(19) United States
(12) Patent Application Publication
(10) Pub. No.: US 2004/0012822 A1
(43) Pub. Date: Jan. 22, 2004

(54) Facsimile machine and method of updating charge table

(76) Inventors: Shunichi Toyoshima, Ibaraki (JP); Tadashi Tsutsumi, Saitama (JP)

Correspondence Address: MORRISON & FOERSTER LLP, 1650 TYSONS BOULEVARD, SUITE 300, MCLEAN, VA, 22102, US

(21) Appl. No.: 10/421,951

(22) Filed: Apr. 24, 2003

(30) Foreign Application Priority Data
Apr. 26, 2002 (JP) 2002-125764

(51) Int. Cl. H04N 1/40

(52) U.S. Cl. 358/448

(57) ABSTRACT

A facsimile machine rewritably stores a table for storing basic data for calculating a communication charge needed at the time of sending image data in a non-volatile memory constituting a part of a ROM. A control unit of the facsimile machine calculates a communication charge at the time of sending a facsimile by referring to the table, and displays the communication charge on a display unit. Further, the control unit obtains the latest basic data through a predetermined network, and updates the basic data in the table stored in the non-volatile memory to the obtained latest basic data.

### BACKGROUND OF THE INVENTION

1. Field of the Invention

The present invention relates to a facsimile machine.

1. Description of the Related Art

Conventionally, there has been a facsimile machine which has a function for calculating a communication charge (call charge) needed when a user sends a facsimile and informing the call charge to the user by showing it on a display. The calculation of the call charge is based on a charge table registered in a charge table memory of the facsimile machine. The call charges may sometimes be revised. In that case, a service person visits the user to replace the charge table memory of the facsimile machine with a new memory in which the latest charge table is stored, thereby the charge table is updated.

However, telephone service companies have been increasing recently and call charges are often revised. Therefore, a service person's paying a visit to a user every such occasion in order to exchange charge table memories of a predetermined telephone service company to update the charge table, can not timely keep up with appearance of a new telephone service company and revision of call charges. Thus, there is a problem that user's needs can not be satisfied.

### SUMMARY OF THE INVENTION

An object of the present invention is to provide a facsimile machine whose charge tables which are the base for calculating communication charges are easy to update, and a method of easily updating charge tables.

To accomplish the above object, a facsimile machine according to a first aspect of the present invention comprises: a communication unit which sends image data representing an image of an arbitrary manuscript to a terminal of a sendee through a communication line, and receives image data from a sender through the communication line; a storage unit which rewritably stores a table for storing basic data for calculating a communication charge needed at a time of sending the image data from the communication unit; and a control unit which controls the communication unit, and is connected to the storage unit, wherein the control unit calculates the communication charge by referring to the table, and notifies the calculated communication charge to a user.

According to this structure, since the table stored in the storage unit is rewritable, even if a service person does not come to exchange the memories for the charge table as he/she conventionally did, the content of the table can be rewritten in accordance with the latest charge system by a predetermined method.

The storage unit may be so configured as to include a non-volatile memory; and the table may rewritably be stored in the non-volatile memory.

The control unit may obtain latest basic data through a network, and update the basic data stored in the table of the storage unit to the latest basic data.

According to this structure, it is possible to update the content of the table stored in the storage unit by obtaining the latest basic data for the table. Therefore, a user can easily update the content of the table to the latest one even though a service person does not visit the user for exchanging memories.

The basic data may be constituted by code data, and the control unit may receive image data representing code data corresponding to latest basic data from a predetermined sender, translate the received image data into code data by referring to a predetermined translation table, and update the basic data stored in the table of the storage unit to the latest basic data based on the code data obtained by the translation.

According to this structure, it is possible to receive image data representing the latest table by facsimile, translate the content into code data, and update the content of the table stored in the storage unit based on the code data. Accordingly, even if a service person does not come to exchange memories, a user can easily update the content of the table to the latest one.

The table may store basic data for calculating communication charges of a plurality of communication service companies, and the control unit may calculate a communication charge of one communication service company to be used at the time of sending and a communication charge needed if another communication service company is used by referring to the table, and may notify these communication charges to the user.

According to this structure, since communication charges of a plurality of communication service companies can be notified to a user for comparison, this may benefit a user who wants to use a communication service company providing an economical service.

The control unit may cumulatively store the communication charge needed at the time of sending in the storage unit, calculate a communication charge spent during a predetermined period of time based on the communication charge cumulated during the period of time, and notify the calculated communication charge to the user.

According to this structure, since communication charges spent during a predetermined period of time can be added up and the obtained sum can be notified to a user, this will help the user.

To accomplish the above object, a method of updating a charge table according to a second aspect of the present invention is a method of updating a charge table which is stored in a facsimile machine and is for storing basic data for calculating a communication charge needed at a time of sending predetermined image data, the method comprising: a step of obtaining latest basic data through a predetermined network; and a step of updating the charge table based on the latest basic data corresponding to the basic data.

The step of obtaining may include a step of accessing a server which provides the latest basic data, and a step of downloading the latest basic data from the server.

The step of obtaining may receive image data representing code data corresponding to the latest basic data, the method may further comprise a step of translating the received image data into code data by referring to a predetermined translation table, and the step of updating may update the charge table based on the code data obtained by the translation in the step of translating.

### BRIEF DESCRIPTION OF THE DRAWINGS

These objects and other objects and advantages of the present invention will become more apparent upon reading of the following detailed description and the accompanying drawings in which:

FIG. 1 is a block diagram showing electrical connection of a facsimile machine according to an embodiment of the present invention;

FIG. 2 is a conceptual diagram showing a telephone service company table and charge tables used by the facsimile machine shown in FIG. 1;

FIG. 3 is an explanatory diagram showing one example of a call charge system;

FIG. 4 is a flowchart of a charge calculation processing performed by the facsimile machine shown in FIG. 1;

FIG. 5 is an explanatory diagram showing one example of a display screen displayed by the facsimile machine shown in FIG. 1;

FIG. 6 is an explanatory diagram showing one example of another display screen displayed by the facsimile machine shown in FIG. 1;

FIG. 7 is a flowchart of a first updating processing performed by the facsimile machine shown in FIG. 1; and

FIG. 8 is a flowchart of a second updating processing performed by the facsimile machine shown in FIG. 1.

### DETAILED DESCRIPTION OF THE PREFERRED EMBODIMENT

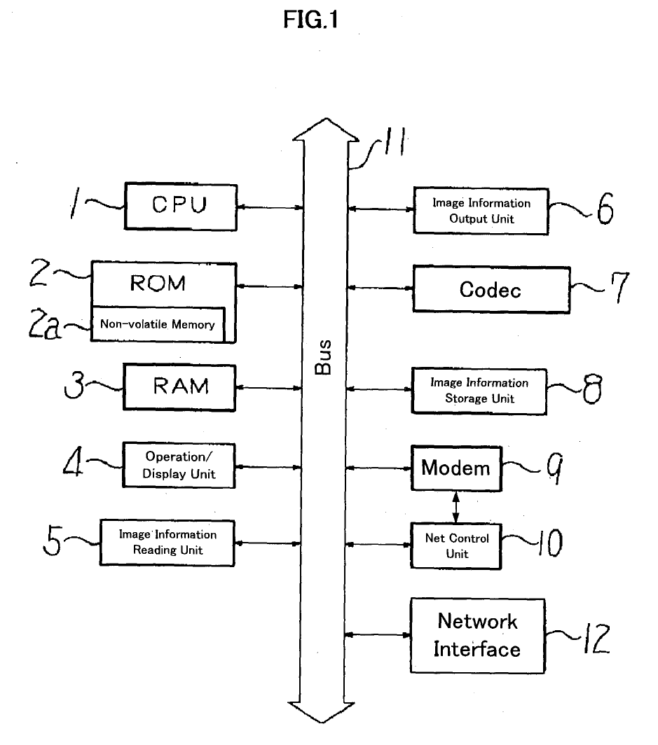

FIG. 1 is a block diagram showing a schematic hardware structure of a facsimile machine according to the embodiment of the present invention. A CPU (Central Processing Unit) 1 constitutes a microcomputer together with a ROM (Read Only Memory) 2 and a RAM (Random Access Memory) 3, and executes various control processing, such as processing for controlling each part of the facsimile machine and processing for controlling facsimile transmission.

The ROM 2 stores control programs to be executed by the CPU 1. In order to determine a calling distance based on a phone number of a calling partner, the ROM 2 further stores a distance translation table which shows correspondence among a phone number, an area name corresponding to the inter-city code and intra-city code included in said phone number, and a distance between said area and the location where the facsimile machine is set. Further, the ROM 2 stores a character/symbol translation table necessary for translating character data and symbol data contained in image data which is acquired when an image of a charge table is received, into code data constituting later-described basic data.

At least a part of the ROM 2 is constituted by a non-volatile memory 2a. As will be described later, the non-volatile memory 2a stores basic data necessary for calculating a communication charge required at the time of facsimile transmission, in a table format.

The RAM 3 serves as a work area, and rewritably stores various information. Further, the RAM 3 cumulatively stores a call charge calculated in a later-described charge calculation processing, each time a facsimile is transmitted.

Hereinafter, the CPU 1 will be referred to as a control unit 1 for explanatory convenience' sake. Usually, the control unit 1 includes the above-described ROM 2 and RAM 3.

An operation/display unit 4 has a display having a touch panel function. The operation/display unit 4 displays a working state of the facsimile machine. The operation/display unit 4 displays various input screens and receives corresponding operations from a user. Further, the operation/display unit 4 displays various output screens for notifying the user of required call charges, etc. An image information reading unit 5 is, for example, a scanner, and reads the image of a manuscript to be sent by facsimile. An image information output unit 6 is for outputting image information on a recording sheet and is constituted by, for example, a laser printer employing an electrophotography method.

A CODEC 7 performs data compression. (compression coding) of image information to be transmitted, and also restores (decodes) received image information which is compression-coded into the original image information. An image information storage unit 8 stores a large number of image information which are compression-coded. A modem 9 realizes modem functions corresponding to the G3 standard, and has a lower speed modem function for exchanging transmission control protocols and a higher speed modem function for mainly transmitting image information.

The net control unit 10 is a device for connecting the present facsimile machine to a PSTN (Public Switched Telephone Network), and has an automatic calling/answering function. The net control unit 10 constitutes a communication device together with the modem 9.

A network interface 12 is an interface (I/F) corresponding to a communication protocol of a predetermined network. As will be described later, the network interface 12 serves as a communication device when the latest charge table data is downloaded through a network such as the internet.

These structural elements are connected to an internal bus 11 via an interface (I/F) (not shown). Data exchange between these structural elements is performed mainly through the internal bus 11. It should be noted that data exchange between the net control unit 10 and the modem 9 is performed directly.

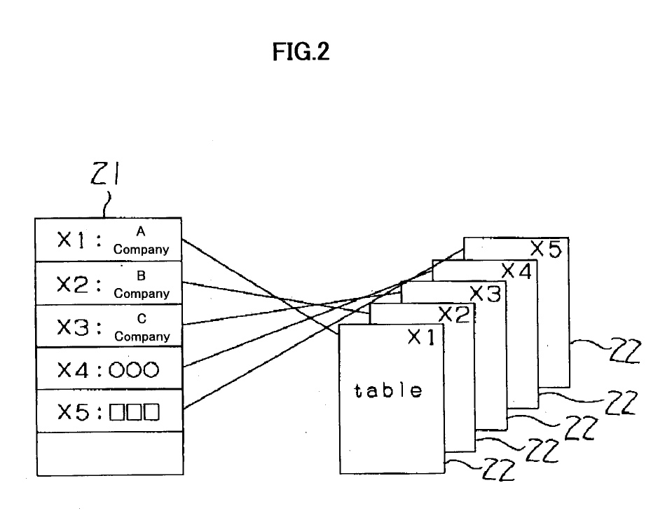

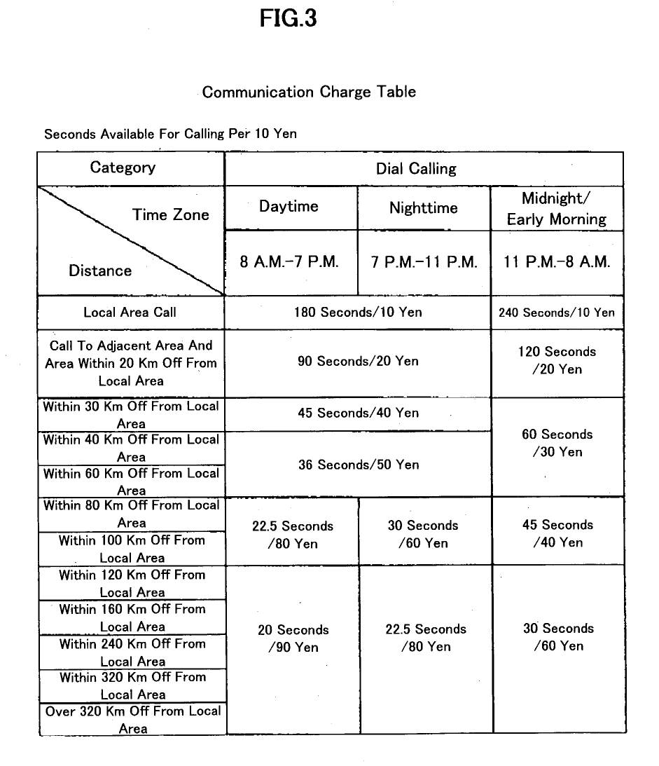

As described above, the non-volatile memory 2a stores basic data for calculating a call charge required when image data is faxed. This basic data includes a telephone service company table 21 and a plurality of charge tables 22. As shown in FIG. 2, the charge tables 22 are stored in association with corresponding telephone service companies on the telephone service company table 21. Specifically, one telephone service company is registered in one section of the telephone service company table 21 (or if one telephone service company provides different telephone services such as a service through a public telephone line and a service through a facsimile line, each telephone service is registered independently). Each charge table 22 stores basic data based on the call charge system of a corresponding telephone service company (or a corresponding telephone service). FIG. 3 shows one example of a charge system. In the example of charge system shown in FIG. 3, the call charge changes in accordance with time zones and calling distances.

As described above, the telephone service company table 21 and the charge tables 22 are associated. Therefore, if a specific telephone service company (or a specific telephone service) is used, the control unit 1 can refer to the telephone service company table 21 and specify the charge table 22 of the specific telephone service company, in order to use the specified charge table 22 in a later-described calculation of the call charge.

Next, a charge calculation processing performed by the control unit 1 using the telephone service company table 21 and the charge tables 22 will be explained.

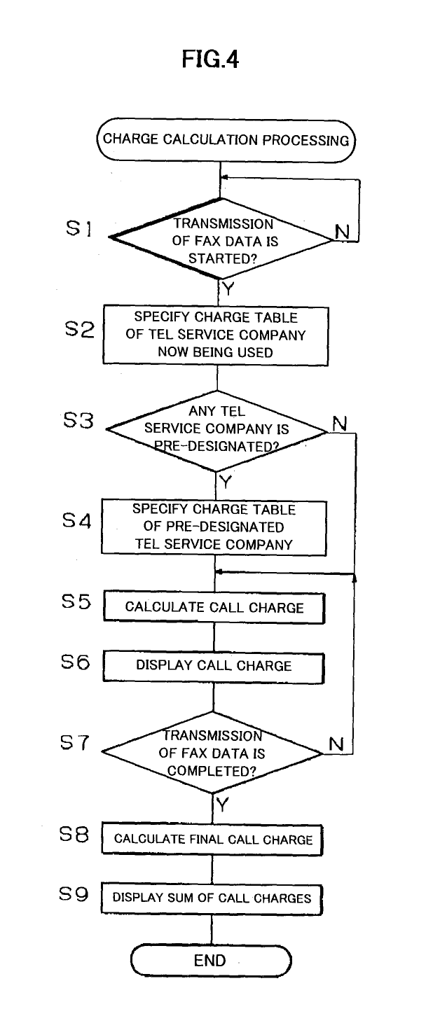

FIG. 4 is a flowchart showing the charge calculation processing performed by the control unit 1. When transmission of facsimile data to a specific person is started (step S1; Yes), the control unit 1 specifies the charge table 22 of the telephone service company whose service is now being used, based on the telephone service company table 21 (step S2). Further, in a case where a user has designated a telephone service company in advance by operating the operation/display unit 4 (step S3; Yes), the control unit 1 specifies the charge table 22 corresponding to a section on the telephone service company table 21 in which the designated telephone service company is registered (step S4).

Suppose that the user has pre-designated a telephone service company (or a telephone service) whose call charges the user wants to know for comparison with the call charges of the telephone service company (or telephone service) to be actually used. To be more specific, the user inputs an instruction for selecting the telephone service company to be actually used, and the telephone service company requested for call charge comparison from among the telephone service companies whose basic data are stored from a telephone service company registration screen (not shown) which is displayed on the display of the operation/display unit 4. In response to this instruction, the control unit 1 registers the selected telephone service companies in the ROM 2.

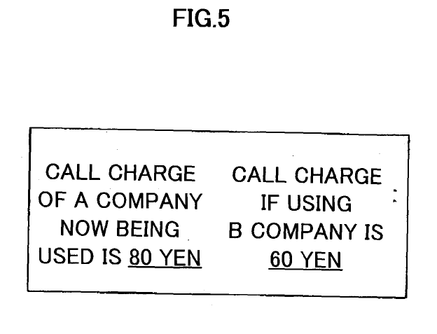

The control unit 1 refers to the charge table 22 of the telephone service company which is now being used, and if the user has pre-designated any telephone service company, also refers to the charge table 22 of the designated telephone service company. Further, the control unit 1 determines the calling distance by referring to the above-described distance translation table based on the telephone number of the calling partner and counts the calling time based on a clock (not shown) comprised by the present facsimile machine in order to calculate the call charges of both of the telephone service companies (step S5). Then, the control unit 1 displays the call charges on the display of the operation/display unit 4 (step S6). FIG. 5 shows one example of the display screen shown on the display of the operation/display unit 4. In this example, the call charge of a company A which is now being used, and the call charge of a company B which is pre-designated by the user are displayed.

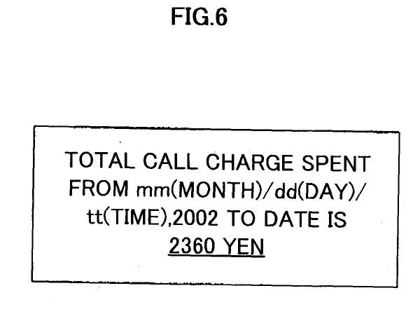

In a case where transmission of facsimile data to the calling partner is continuing (step S7; No), the control unit 1 returns to step 5 to repeat the processes therefrom. On the contrary, in a case where transmission of facsimile data is completed (step S7; Yes), the control unit 1 calculates the final call charge by referring to the charge table 22 based on the calling time and calling distance (step S8). Next, the control unit 1 cumulatively stores the final call charge in the RAM 3. The control unit 1 stores a call charge calculated each time facsimile data is transmitted, by adding the call charge to the past call charge stored in the RAM 3. That is, the control unit 1 updates the recorded sum of the past call charges spent during a predetermined period, by adding the call charge required for the present facsimile transmission, and stores the updated sum in the RAM 3. Then, as shown in FIG. 6, the control unit 1 displays the sum, which is obtained by adding up all the call charges spent during the predetermined period, on the display of the operation/display unit 4 (step S9). This sum may be reset in response to a user's operation from an input screen (not shown) on the operation/display unit 4. In that case, the control unit 1 starts the adding-up from the amount after the reset.

As explained above, according to the present facsimile machine, the control unit 1 calculates the call charge corresponding to the telephone service company actually used, and the call charge corresponding to the telephone service company designated by the user. The control unit 1 informs the plurality of calculated call charges to the user for comparison, by displaying the charges on the display of the operation/display unit 4. This is helpful for a user who wants to use a telephone service company which is convenient for the user cost-wise.

Further, the control unit 1 adds up call charges spent during a predetermined period and displays the obtained sum along with the period for adding-up on the display of the operation/display unit 4. This also helps a user who wants to regularly know the call charges spent.

Next, a processing for updating the telephone service company table 21 and the charge tables 22 will be explained.

(First Updating Processing)

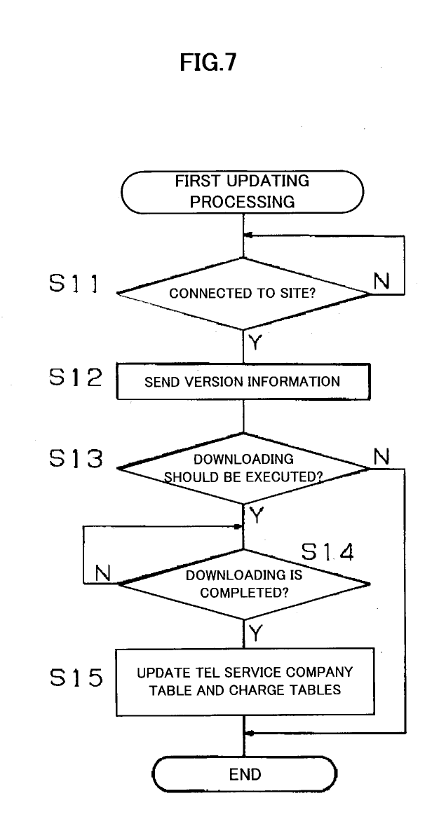

First, a case where the telephone service company table 21 and the charge tables 22 are downloaded through the internet from a site having a predetermined URL (Uniform Resource Locator) operated by a support center or the like of the present facsimile machine will be explained. FIG. 7 is a flowchart showing a first updating processing.

For example, the user operates the operation/display unit 4 and inputs an instruction for connecting to the site which is pre-registered. As shown in FIG. 7, the control unit 1 controls the network interface 12 in response to the instruction and gains access to the registered site (step S11; Yes). Then, the control unit 1 sends version information regarding the version of the telephone service company table 21 and charge tables 22 which are presently stored to the site (step S12). The server of the site to which the version information is sent, determines whether or not the received version information represents the latest version. In a case where determining that the received version information represents an old version, the server starts downloading the latest version of the telephone service company table 21 and charge tables 22 to the accessing facsimile machine (step S13; Yes). When the downloading is completed (step S14; Yes), the control unit 1 updates the telephone service company table 21 and charge tables 22 stored in the non-volatile memory 2a by the received telephone service company table 21 and charge tables 22 (step S15).

In a case where the server determines that the received version information represents the latest version, it sends a message that the version of the stored tables is the latest one to the facsimile machine and cuts the connection with the facsimile machine. The control unit 1 displays the received message on the display of the operation/display unit 4 to inform the user of the message.

(Second Updating Processing)

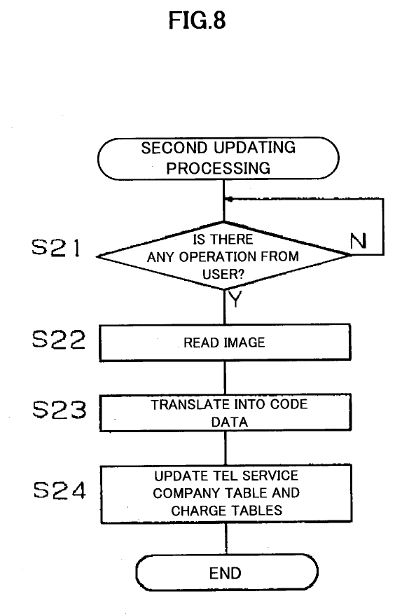

Next, a case where image data of a manuscript on which code data of the telephone service company table 21 and charge tables 22 are written is received by the facsimile machine from the support center will be explained. FIG. 8 is a flowchart showing the second updating processing.

In this case, the user asks the support center for revision information for the telephone service company table 21 and charge tables 22. If the version of the stored telephone service company table 21 and charge tables 33 is not the latest one, the user requests the support center to transmit a sheet on which code data of the telephone service company table 21 and charge tables 22 is printed.

The control unit 1 receives image data of the sheet transmitted from the support center in response to the above request, and prints out the received image data on a predetermined sheet from the image information output unit 6. The user controls the operation/display unit 4 to display an updating processing screen (not shown), and selects “table updating processing”. The user sets the sheet on which the code data of the telephone service company table 21 and charge tables 22 is printed on the image information reading unit 5, and selects “table reading processing” on the updating processing screen of the operation/display unit 4 (step S21; Yes). In response to this operation, the control unit 1 reads the image of the sheet by the image information reading unit 5 (step S22). Further, the control unit 1 translates characters and symbols in the read image data into code data by referring to the above-described character/symbol translation table stored in the ROM 2 (step S23). Due to this, code data of the telephone service company table 21 and charge tables 22 corresponding to the latest version is obtained. Then, the user selects “data updating” on the updating processing screen of the operation/display unit 4. In response to this operation, the control unit 1 updates the telephone service company table 21 and charge tables 22 stored in the non-volatile memory 2a based on the code data obtained by the translation in step S23 (step S24).

As explained above, according to the present facsimile machine, the telephone service company table 21 and charge tables 22 stored in the non-volatile memory 2a can be easily rewritten into the latest ones by downloading the latest version through a network or by receiving the latest version by facsimile. Therefore, the contents of the tables storing the basic data for calculating call charges can be easily rewritten, even if a service person does not visit the user to replace the charge table memories as before.

The present invention is not limited to the above-described embodiment, but can arbitrarily applied and modified.

For example, as explained, the communication network is a public switched telephone network (PSTN) in the above described embodiment. However, the communication network is not limited to a public switched telephone network, but may be an arbitrary network. For example, the communication network may be an internet telephone network through the internet, an optical fiber, a special-purpose line such as a CATV line, and a combination of these, etc.

According to the explanation of the above-described embodiment, the control unit 1 displays call charges, etc. of a plurality of telephone service companies on the display of the operation/display unit 4 in order to notify the call charges, etc. to the user. However, the notification means is not limited to this. For example, notification may be done by sounds. Notification by sounds can be easily realized by adding a sound output unit such as a loudspeaker, etc. to the facsimile machine of the above-described embodiment and by storing a sound output program or the like in the ROM 2, etc.

In the above-described embodiment, in the second updating processing, the control unit 1 receives image data including code data sent from the support center, and once prints out the received image data on a sheet from the image information output unit 6. Then, the image information reading unit 5 reads the image on the sheet on which the code data is printed, in order to translate the characters and symbols included in the image into code data. However, the second updating processing is not limited to these procedures, but any procedures may be employable if such procedures include a step of translating image data received by facsimile into code data. For example, the control unit 1 may store received image data once in the RAM 3 and translate the stored image data into code data based on the character/symbol translation table. In this case, since there is no need for the user to print out the received image data on a sheet and read the printed image on the sheet, the procedures will be simplified, and convenience for the user will be improved.

As explained above, according to the present invention, it is possible to provide a facsimile machine whose charge tables which are the base for calculating call charges are easy to update, and a method of easily updating charge tables.

Various embodiments and changes may be made thereunto without departing from the broad spirit and scope of the invention. The above-described embodiment is intended to illustrate the present invention, not to limit the scope of the present invention. The scope of the present invention is shown by the attached claims rather than the embodiment. Various modifications made within the meaning of an equivalent of the claims of the invention and within the claims are to be regarded to be in the scope of the present invention.

This application is based on Japanese Patent Application No. 2002-125764 filed on Apr. 26, 2002 and including specification, claims, drawings and summary. The disclosure of the above Japanese Patent Application is incorporated herein by reference in its entirety.

What is claimed is:

1. A facsimile machine comprising:
a communication unit which sends image data representing an image of an arbitrary manuscript to a terminal of a sendee through a communication line, and receives image data from a sender through said communication line;
a storage unit which rewritably stores a table for storing basic data for calculating a communication charge needed at a time of sending the image data from said communication unit; and
a control unit, which controls said communication unit, and is connected to said storage unit,
wherein said control unit calculates the communication charge by referring to said table, and notifies the calculated communication charge to a user.

2. The facsimile machine according to claim 1,
wherein: said storage unit is so configured as to include a non-volatile memory; and
said table is rewritably stored in said non-volatile memory.

3. The facsimile machine according to claim 1,
wherein said control unit:
obtains latest basic data through a network; and
updates the basic data stored in said table of said storage unit to the latest basic data.

4. The facsimile machine according to claim 1,
wherein
the basic data is constituted by code data,
said control unit:
receives image data representing code data corresponding to latest basic data from a predetermined sender;
translates the received image data into code data by referring to a predetermined translation table; and
updates the basic data stored in said table of said storage unit to the latest basic data based on the code data obtained by said translation.

5. The facsimile machine according to claim 1,
wherein:
said table stores basic data for calculating communication charges of a plurality of communication service companies; and
said control unit calculates a communication charge of one communication service company to be used at said time of sending and a communication charge needed if another communication service company is used by referring to said table, and notifies these communication charges to the user.

6. The facsimile machine according to claim 5, further comprising a display unit which is connected to said control unit,
wherein said control unit controls said display unit to display the plurality of calculated communication charges in order to notify the communication charges to the user.

7. The facsimile machine according to claim 1,
wherein said control unit cumulatively stores the communication charge needed at said time of sending in said storage unit, calculates a communication charge spent during a predetermined period of time based on the communication charge cumulated during the period of time, and notifies the calculated communication charge to the user.

8. A method of updating a charge table which is stored in a facsimile machine and is for storing basic data for calculating a communication charge needed at a time of sending predetermined image data, said method comprising:
a step of obtaining latest basic data through a network; and
a step of updating said charge table based on the latest basic data corresponding to said basic data.

9. The method of updating a charge table according to claim 8,
wherein said step of obtaining includes:
a step of accessing a server which provides the latest basic data; and
a step of downloading the latest basic data from said server.

10. The method of updating a charge table according to claim 8,
wherein:
said step of obtaining receives image data representing code data corresponding to the latest basic data;
said method further comprises a step of translating the received image data into code data by referring to a predetermined translation table; and
said step of updating updates said charge table based on the code data obtained by said translation in said step of translating.
